(19) United States
(12) Patent Application Publication
(10) Pub. No.: US 2014/0070638 A1
(43) Pub. Date: Mar. 13, 2014

(54) COIL ASSEMBLY FOR THREE PHASED TRANSVERSE AXIAL FLUX MULTI DISK MACHINES

(71) Applicant: Jon Eirik Brennvall, Trondheim (NO)

(72) Inventor: Jon Eirik Brennvall, Trondheim (NO)

(73) Assignee: GREENWAY ENERGY AS

(21) Appl. No.: 14/006,917

(22) PCT Filed: Mar. 23, 2012
(86) PCT No.: PCT/NO12/50051

§ 371 Date: Nov. 27, 2013

(30) Foreign Application Priority Data
Mar. 24, 2011 (NO) 20110441

(51) Int. Cl. H02K 3/28; H02K 21/24; H02K 9/19

(52) U.S. Cl. CPC H02K 3/28; H02K 9/19; H02K 21/24
USPC 310/54; 310/208

(57) ABSTRACT

This patent describes a coil assembly for a three phased permanent magnet (PM) iron free axial flux multi disc electric machine. The coil assembly is assembled from coil elements (15) made of flat wire (9), and then machined so they can be assembled into a flat disk. The coil elements (15) can further be inserted into a frame (22), and the coil elements (15) can be connected by wires (29) which do not cross each other.

### TECHNICAL FIELD OF THE INVENTION

The present invention relates to coil assembly for three phased transverse axial flux, multi disk machines where the coil elements are wound of flat wire/foil.

### BACKGROUND FOR THE INVENTION

Machines with high torque and power to weight/volume ratio and good efficiency have many applications, especially in transportation where weight is of considerable importance. Such type of transportation may for example be land vehicles or aeroplanes of various types.

One electric machine type which does have high theoretical power to weight/volume ratio is transverse axial flux multi disk machines. The advantage of this type of machine is that the magnetic flux goes through the entire machine, and therefore iron is not necessary to change the magnetic fields direction for each disk, thus saving iron and weight. It is, however, a difficult machine to produce, because the coils must have sufficient strength to resist the electromagnetic forces they are exposed to without the support of back iron. Also it is difficult to wound the coils in this machine because the optimal winding pattern tends to result in solutions which are difficult to assemble, at least for iron free machines where the thread has constant thickness.

WO 2010/071441 is an example of such a solution, disclosing an electrical machine with a rotor with magnets carried by an annular carrier, at which a magnet field is created over an air gap between two rotor parts, at which an ironless stator with windings is arranged. The stator which is assembled of sections with channels for circulation of coolant, and having windings with an annular, compact central part providing the active part of the stator. WO 2010/071441 discloses also a method for manufacturing of stator sections for such electrical machines, wherein a winding is embedded in an electrically insulating casting material for providing a rigid element. A coil is arranged in one part of a bisected shell housing or a bisected casting mould, and the shell housing or mould is closed, casting material is introduced through an opening and the inner part of the housing or mould is subject to underpressure and possibly vibration.

### SUMMARY OF THE INVENTION

An object of the present invention is to provide an improved three phased, permanent magnet, iron free axial flux multi disc machine.

Another object of the invention is to provide a coil assembly with reduced both weight and space requirements, i.e. the volume of the machine, without reducing the power and torque output of the machine, thus to improved high and enhanced torque and power to weight/volume ratio and good efficiency.

Another object is to provide an improved coil assembly which easily may be prefabricated and assembled into a complete coil.

Another object of the invention is to provide coils configured in such way that they are easy to wind.

Yet another object of the invention is to provide a space saving three phased, permanent magnet iron free flux multi disc machine.

A further object of the present invention is to provide a machine where it is possible to connect the various coil elements with connectors which does not cross each other.

Yet another object of the invention is to provide a coil assembly enabling reduction of production costs for the machine in which the coils form an integrated part.

The objects are achieved by a motor as further defined in the independent claim, while various embodiments and/or alternatives are defined by the dependent claims.

In the coil assembly, each coil element is provided with eight slots, four on each side of the coil element, shaped and configured so that it is possible to assemble the coil elements into a circular coil flat and thin disk with approximate same thickness as the width of the flat wire/foil used for winding the coil assembly.

The angle α between the opposing coil legs in each coil element may preferably be 5*360°)/(2*6*n) where n is an integer equal to or larger than three and the extension of the coil legs meet in the centre of the coil, since this is a requirement for the coil elements to assemble into a complete 3 phased coil.

According to an embodiment, the halves of the coils are wound counter clockwise and the other halves clockwise and when assembled the different type of coil elements are collected into groups of three, making it possible to connect the coil elements with connector wires which do not cross each other.

Further, the coil elements after assembly may preferably be inserted into a coil frame, prefabricated with an edge for the heads of the coil elements, holes for the connector pins and on the back side slots for the connector wires arranged so that the connector wires do not cross each other, thus providing an assembled, flat packed machine with reduced lateral foot print.

The coil frame may be provided with holes and slots where the slots can be fitted with O-rings which will provide suitable sealing for the cooling fluid and allow cooling fluid to be in contact with both sides of the coil elements. Further, the holes and slots may be arranged so that cooling fluid can flow from coil assembly to coil assembly if several coil assemblies mounted together in a multidisc machine.

As indicated above, the present invention relates to a three phased, permanent magnet (PM), iron free, axial flux, multi disc, electric machine, comprising one or more rotor discs with PMs arranged to rotate on a shaft and a stator in the form of two or more coil discs mounted between and on each side of the rotor discs inside a housing recognised by that the coil are made up of separate coil elements made of flat wire/foil which are modified before or after winding so they can be assembled to a complete coil, including a system for connecting the coil elements correctly.

According to this invention flat wire is used instead of traditional round wire to make the coils elements, providing a substantially quadrangular cross section at any place along the coil element. The coils elements are then machined in a way that does not cause short circuit or wire break, making it possible to assemble and fit the coils elements together to a coil assembly for a three phased electric machine, preferably permanent magnet machine, even though other types of machines also are possible. The coils elements are fitted with contacts so the entire coil can be made up of coil elements, where each element is relatively easy to mass produce. It is the specific coil form and connector system which form the basis for the present invention.

A machine assembled with the coil elements according to the present invention may be made smaller, lighter and cheaper without reducing the effect output or torque delivered. The machine will be more compact, giving a smaller footprint at least laterally or in depth. Hence, a machine having improved high and enhanced torque and power to weight/volume ratio and good efficiency is provided.

### SHORT DESCRIPTION OF THE DRAWINGS

One embodiment of the invention will be described in further details below, referring to the drawings where:

FIG. 1a shows a single coil element seen from front, while FIG. 1b shows the coil element seen from side with slots and connector pins but without the connecting wires;

FIG. 2a and FIG. 2b shows the difference between counter clockwise wounded elements and clockwise wounded elements by showing the first revolution of the wire, while FIG. 2c shows said first revolution seen from a side;

FIG. 3 shows schematically a mould or a template used for winding the coil elements, the coil element shown being wound in anti clockwise direction;

FIG. 4a shows schematically how several coil elements are assembled and fitted together; while FIG. 4b shows schematically a side view of the assembled coil elements shown in FIG. 4a;

FIG. 5a shows schematically a top view of a connector wire used for connecting the coil elements into a three phased electric machine coil assembly; while FIG. 5b shows schematically a view in perspective of the connector wire shown in FIG. 5a, and FIG. 5c shows schematically en end view of the connector wire shown in FIG. 5a;

FIG. 6a shows schematically a top view of a plastic frame on which the coil elements shall be mounted; FIG. 6b shows schematically a side view of the plastic frame shown in FIG. 6a; FIG. 6c schematically in an enlarge scale, the part of plastic frame shown in FIG. 6b being inside the circle on top of FIG. 6b; FIG. 6d shows schematically the rear side of the plastic frame shown in FIG. 6a after all of the coil elements are positioned on the opposite side and with the connector pins extending through the holes in the plastic plate, projecting outwards from the rear side with connector wires attached; and FIG. 6e shows schematically in an enlarged scale a sector of the rear side of the plastic plate shown in FIG. 6d;

FIG. 7 shows the coil mounted into the frame, including O-rings (30) which seals off cooling fluid, but without the epoxy in which the coil elements must be embedded in;

FIG. 8 shows coils and magnets; and

FIG. 9 shows a coil which is modified so it is space for iron (sheet metal) between the wires.

### DETAILED DESCRIPTION OF THE INVENTION

The class of electric machines for which this invention is best suited is transverse axial flux, iron free permanent magnet multi disk machines but it can be also used for other types of machines as well. The machine defined by claim 1 is universal for machines with any number of phases, while the machine defined in claims 2 and 3 is specific for three phased machines. The invention relates in particular to a coil element 15 which is suited for mass produced, and then to be assembled into a compact coil.

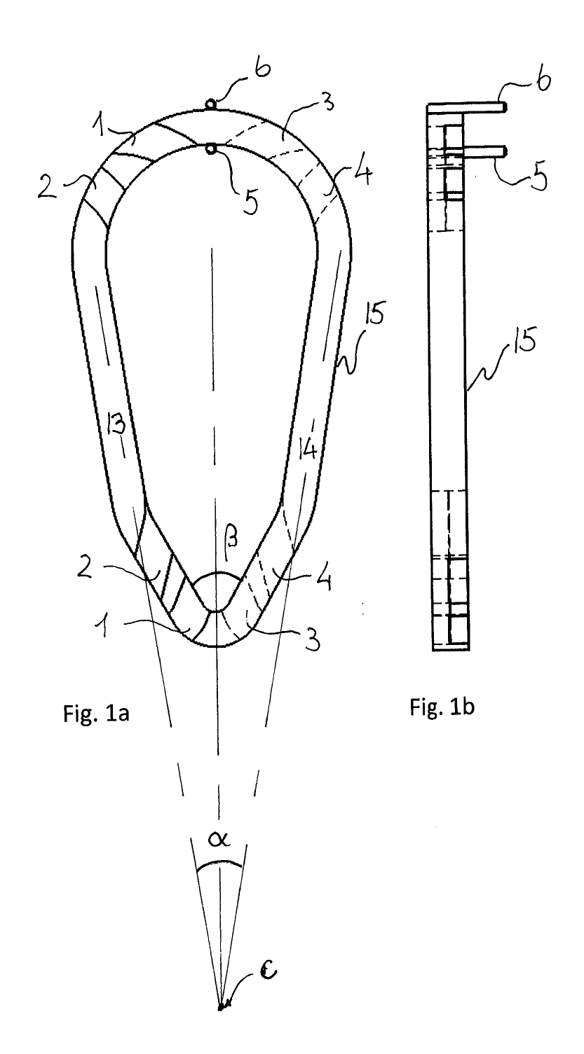

FIG. 1a shows a single coil element 15 according to the invention, seen from front, while FIG. 1b shows the coil element 15 seen from the side with slots 1-4 for receiving adjacent coil elements 15 and with connector pins 5,6. For the sake of clarity, the flat wires 9 forming the coil, are not shown in FIG. 1.

The coil element is made up of a number of windings of a continuous flat insulated wire 9. The flat insulated wire 9 has dimensions which may would make it more appropriate to call it a strip of foil, but it will be called flat wire 9 through this document. One end of the flat wire 9 is connected to a contact pin 5. The flat wire 9 is then wound on to a mould 10 with appropriate shape until the coil element 15 has received correct and intended thickness. The flat wire 9 is then terminated into another connector pin 6. Slots 1-4 are made in the coil element for receiving corresponding sections of a neighbouring, adjacent coil element 15 when assembled. These slots can be made in two ways. They can be milled into the coil element 15 after completion of the winding process. It is also possible to cut out pieces of the flat wire 15 during the winding process. Either way the result is a coil element as the one shown in FIG. 1. During such operation, care should be taken to secure appropriate insulation between the various flat wires 9 forming the coiled element 15 and the machined/milled surfaces. Said machined surfaces may for example be insulated and/or coated by an appropriate epoxy or the like.

For a three phased machine the coil legs 13,14 must be inclined with respect to each other at an angle α of 5*360°)/(2*6*n) where n is an integer equal to or larger than three and the extension of the coil legs 13,14 must meet in the centre C of the assembled machine. This is a requirement if the fill factor of the coil 15, i.e. the percentage copper filling in a total available area, shall be optimal. It is possible to deviate slightly from this requirement, but no designer would like to do so. Further, the top end of the coil element 15 has an semi-circular arched shape interconnecting the two coil legs 13,14, while the opposite end of the coil element 15 is provided with two lower coil legs forming an angle β which is larger than the angle α, the extreme end being rounded off. It should be appreciated that the slots 1-4 are arranged in the upper semi-circular end portion of the coil element 15 and in the portion of the lower end of the coil element 15 forming the angle β with each other.

As indicated in FIGS. 1a and 1b, the slots 1,2 for an adjacent coil element (not shown) intended to be assembled on the left side of the coil element 15, are provided on the front side of the coil element 15 shown, while the slots 3,4 for an adjacent coil element 15 (not shown) to be arranged on the right side of the coil element 15 shown, are provided on the rear side of the coil element shown, enabling the various coil elements to be arranged in a flat stacked position, the total thickness of the joint between two adjacent coil elements 1|5 being substantially equal to the thickness of one coil element 15.

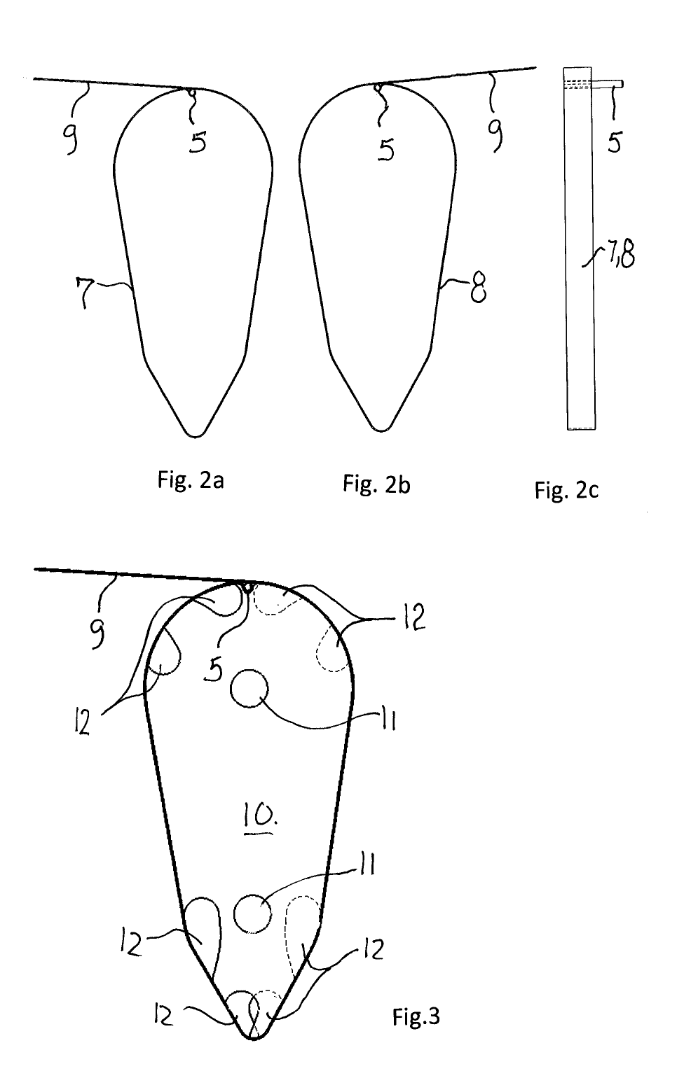

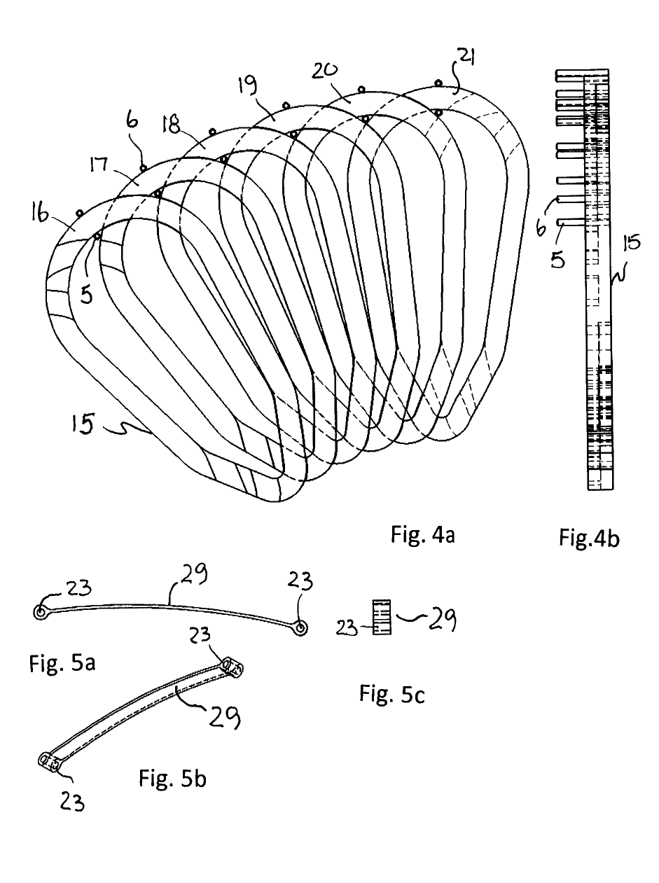

FIG. 2a and FIG. 2b shows the difference between counter clockwise wounded elements 7 and clockwise wounded elements 8 by showing the first revolution of the wire (9). FIG. 2c shows the first revolution element seen from the side. To make it possible to connect the coil elements in the correct way without having crossing connector wires 29 half of the coil elements 15 be wound counter clockwise as indicated in FIG. 2a or clockwise as indicated in FIG. 2b. The side view in FIG. 2 is identical for both front views. As indicated in FIG. 4, three counter clockwise elements 16,17,18 will be followed by three clockwise elements (19, 20, 21), and so forth. Such order or sequence can of course be mirrored or rotated. The flat wire 9 may for example be delivered continuously from a reel (not shown) or the like containing insulated flat wire 9.

FIG. 3 shows a mould or template 10 used for winding the coil elements 15. As shown in FIG. 3, the mould 10 may preferably be provided with holes 11 so that it can be fixed by means of screws and nuts between plates (not shown) during the winding process. The winding as shown is a winding in counter clockwise direction.

Upon completed winding process, the plates are then removed so it is possible to lift the produced coil elements 15 free of the mould 10. Most probably it is preferable to mill the slots 1-4 in the coil elements 15 while it is still attached to the mould 10. For such purpose, the mould 10 may preferably be provided with slots or recesses 12 in the mould 12 as indicated in FIG. 3, configured so as to provide the required slots 1-4 in the coil element 15. This may complicate reuse of the mould.

FIG. 4a shows schematically a front view of several coil elements 15, fitted and assembled together, while FIG. 4b shows schematically a side view of the assembled coil elements 15 shown in FIG. 4a. As indicated in FIG. 4a, the coil elements 15 are placed on top of each other in a sequential order 16-21, laterally displaced with respect to each other. The right side of coil element 15, denoted 17, is placed on top of the adjacent side part (the left side) of the neighbouring coil element 15, denoted 18 in the Figure, while the left side of the coil element 15, denoted 17 in the Figure is placed under the right side of the coil element 15, denote 16 in the Figure. This configuration is valid for all the coil elements 15 shown in FIG. 4a. Further, all the coil elements are configured with slots 1-4, enabling to arrange the coil elements 15 in an assembled configuration with a height corresponding to one coil element 15 as shown in FIG. 4b. As further indicated in FIGS. 4a and 4b, the contact pins 5 are arranged on the inside of the each coil element 15 arch, while the contact pins 6 are arranged on the outside of the coil element 15 arch, both the contact pins 5 and 6 projecting sidewise in the same direction as indicated in FIG. 4b.

FIG. 5a shows schematically a top view of a connector wire 29 used for connecting the coil elements 15 into a three phased electric machine coil assembly; while FIG. 5b shows schematically a view in perspective of the connector wire 29 shown in FIG. 5a, and FIG. 5c shows schematically en end view of the connector wire 29 shown in FIG. 5a. The connector wire 29 is configured to connect the connector pins 5, 6 of different coil elements 15 respectively, so that connector pin 5 of a first coil element 15 is connected in series to the connector pin 6 of a third following coil element 15 in succession by means of the connector wire 29. Referring tio FIG. 4a, this means that the connector pin 5 on coil element 15 denoted as 16 is connected to connector pin 6 on the coil element 15 denoted as 19, using a connector wire 29 as disclosed in FIG. 5a. For such purpose the ends of each connector wire are provided with a hole 23′, configured to receive a connector pin 5,6. The connector wire 29 may preferably have a slightly curved shape so as to prevent the various connector wires 29 in an assembly to be in contact with a neighbouring connector wire 29. The connector wires 29 may for example be cut by laser, water etc. for prototypes and stamped in mass production.

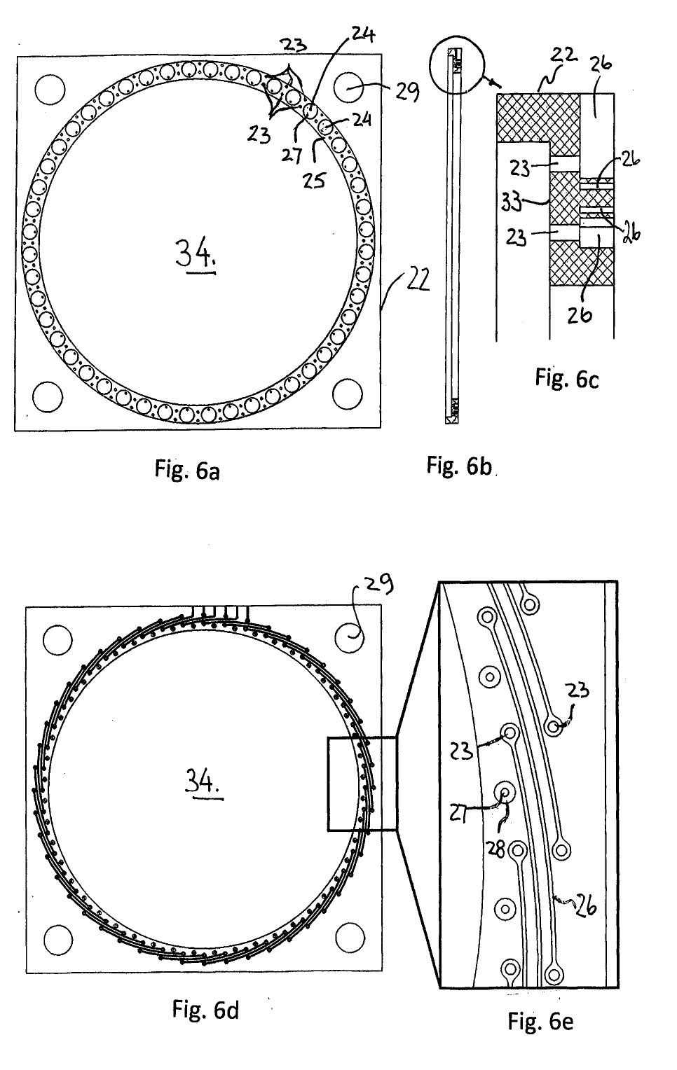

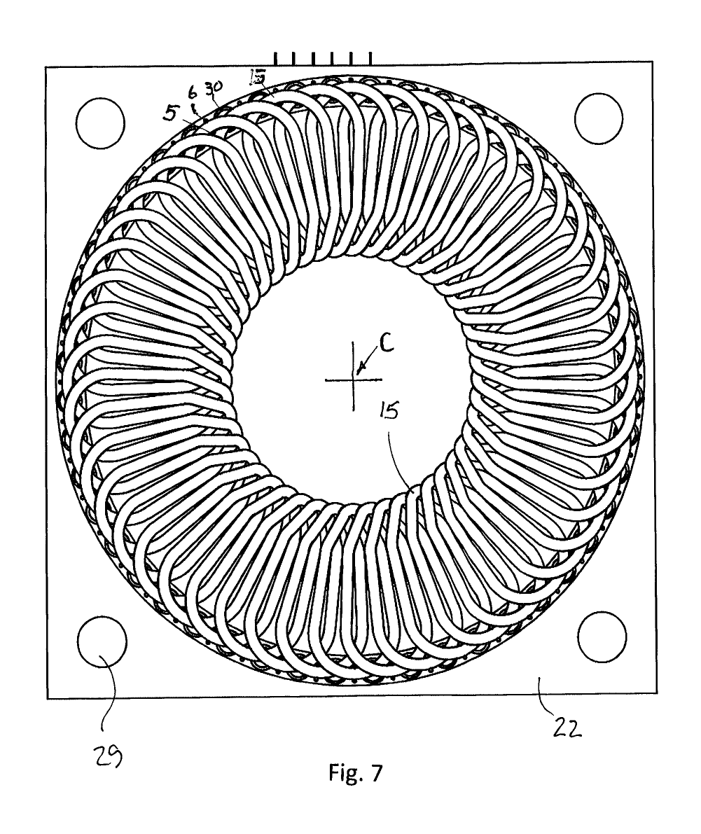

FIG. 6a shows schematically a top view of a plastic frame 22 on which the coil elements 15 shall be mounted; FIG. 6b shows schematically a side view of the plastic frame 22 shown in FIG. 6a; FIG. 6c shows in enlarged scale the portion of the plastic frame 22 shown in FIG. 6b encircled by the ring; FIG. 6d shows schematically the rear side of the plastic frame 22 shown in FIG. 6a indicating all the holes 23 and slots 26 and patterns thereof for the connector wires 29, positioned on the opposite side of the plastic frame with respect to the intended position for the assembled coil elements 15; and FIG. 6e shows schematically in an enlarged scale a sector of the rear side of the plastic plate 22 shown in FIG. 6d.

The frame 22 shown is a typical frame 22 on which the coil elements 15 are to be assembled and embedded in epoxy. All the connector pins 5,6 are intended to be pressed through holes 23 in recesses in the frame 22, the holes 23 being intended to be coaxially aligned with the holes 23′ at each end of connector wire 29, thus allowing the connector wire 29 to be attached to the pins 5,6. The connector wires 29 are intended to be pressed onto the connector pins 5, 6 at the same time they are pressed into corresponding slots 26 formed in the surface on the rear side of the frame 22, the end of the pins 5,6 and the connector wires 29 being configured to be more or less flush with the rear surface of the plastic frame 22 when assembled. Since the connector wires 29 do not cross each other, amongst other due to the proposed shape, they do not need to be insulated.

As shown in FIG. 6c, the frame 22 is provided with a centrally arranged circular opening, extending through the frame 22. Along the edge 25 of the centrally arranged circular opening a supporting surface 33 is provided, intended to form a seat for the widest end of each coil element 15, so the coil elements 15 can be assembled on the frame 22. The remainder of the material in the frame makes space for the rotor disk with the permanent magnets in the electric machine. A large diameter hole 34 is provided in the centre of the frame 22. When the coil elements 15 are assembled, they will fill the peripheral part of the opening 34, still leaving an appropriate opening in centre for the shaft of the rotor, the rotor being in the form of magnets as discussed below.

As seen in FIG. 6c the holes 23 for the connector pins 5,6 extend through the seat 33 for the coil elements 15, the holes 23 communicating with the ducts 26 on the opposite side of the frame 22. Further between pairs of holes 23, the supporting surface 33 is further provided with circular recesses 24 intended to house a sealing O-ring 30 and being intended for circulating a coolant through holes 27. In such way, a path for a cooling fluid is provided in the frame 22, enabling the coolant to be brought directly in contact with both sides of the coil elements 15 and therefore give rather efficient cooling since the heat only need to conduct through copper and a thin layer of wire insulation before it goes into the cooling fluid. Both to give the coil element 15 sufficient mechanical strength and to prevent leakage of cooling fluid into the machine the coil elements 15 should be embedded in epoxy or similar. Holes must be made in the epoxy to create path for the cooling fluid.

FIG. 7 shows the coil elements 15 mounted into the frame 22, including O-rings (30) for sealing off cooling fluid, but without the epoxy in which the coil elements must be embedded in, the Figure showing the coil elements 15 in a completed assembly. The epoxy is invisible in the drawing, but an O-ring sealing 30 which seals against the epoxy is visible. With the suggested cooling the inner tips of the coil elements will be the hot spots in the machine. The part of the slots 2, 4 closest to the connector pins 5,6 is the part of the coil elements 15 being most influenced by the cooling. The coil frame 22 has holes 27 and slots or recesses 24, 28 where the slots 24,28 can be fitted with O-rings 30 which will provide suitable sealing for the cooling fluid, allowing cooling fluid to be in contact with both sides of the coil elements 15. The holes 27 and slots or recesses 24, 28 are arranged so that cooling fluid can flow from the coil assembly to coil assembly if several coil assemblies are mounted together in a multidisc, sandwich-type machine. In such case recesses or slots for O-rings, or other types of sealing elements may also be used as sealing between the various layers in the sandwich-type unit.

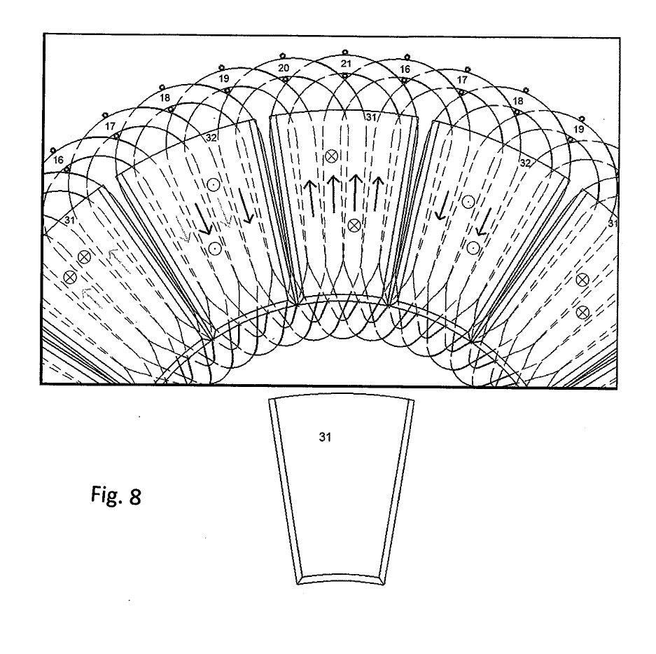

FIG. 8 shows coils and magnets, showing how the coil assembly can work in a motor. The magnets 31,32 are magnetized into the plane 31 or out of the plane 32. A single magnet 31 is shown below the section of the coil-magnet assembly in order to make it easier for the reader to single out the magnet 31 and to identify the magnets 31 by the shape in the assembled view. The arrows indicate current direction. With the given invention it is always possible to make current flow in the same direction in the four coil legs 13,14 which are over the magnet 31,32 at any given time. The magnets 31,32 are supported by e carrier (not shown) with a shaft (not shown) in order to allow the magnets 31,32 to rotate, functioning as a rotor producing the required torque. By the Biot-Savart law all the coil legs 13,14 will interact with the magnets 31,32 to produce torque in the same direction. The magnets 31,32 must be inserted into a coil frame (not shown) which is part of rotor and transfer the torque to the shaft.

The magnets can be replaced with a large number of short circuited rods placed in radial direction, or simply a solid metal (copper or aluminium) to make an induction motor. They can also be replaced by super conductors, but for the lifetime of this patent permanent magnets will probably be the best solution.

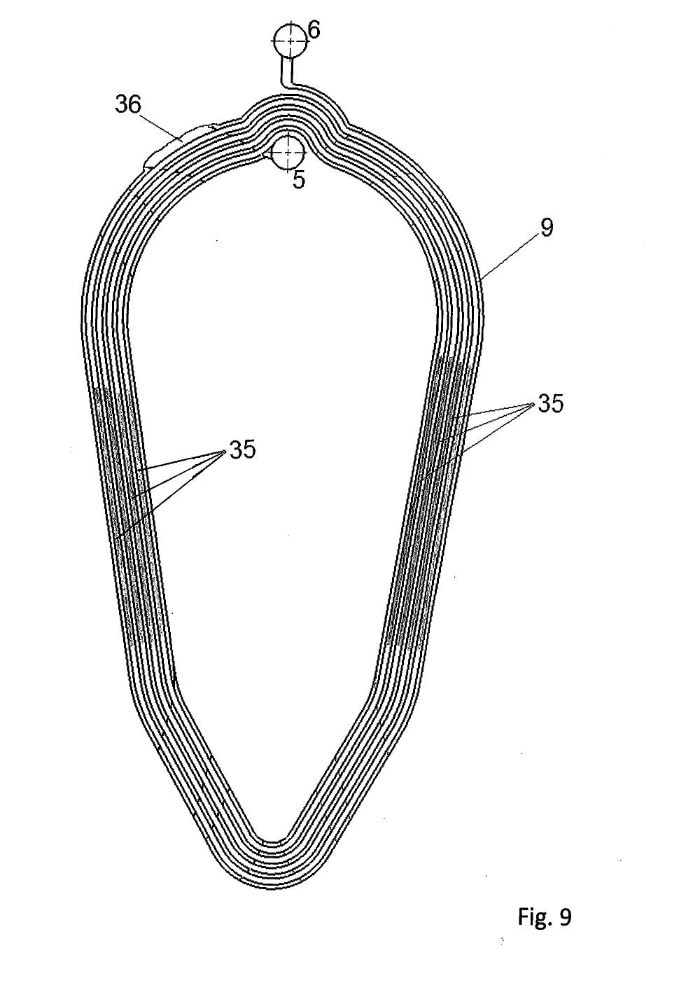

FIG. 9 shows a coil which is modified so there is space for iron 35 (sheet metal) between the wires 9 at least in sections where the present of such iron is beneficiary. As a result the wire is thinner. When the wire 9 is thinner the wire thickness can be increased some places where increased thickness may have an effect on the performance of the system, like for example the part shown in position 36. This can be done to increase power efficiency of the machine and reduce heat generation in specific areas or places in the coil. This is not practical for small machines where the foil or wire is thin, but it can be practical for large machines where the coil can be made directly from a piece of copper using techniques like wire cutting (electrical discharge machining), laser cutting, water cutting or similar.

1) Coil assembly for three phased transverse axial flux multi disk machines where the coil elements are wound of flat wire/foil, characterized by that there in each coil element are made eight slots, four on each side of the coil element, shaped so that it is possible to assemble the coil elements into a circular coil disk with approximate same thickness as the width of the flat wire/foil.

2) Coil assembly according to claim 1, where the angle (α) between the coil legs in each coil element is 5*360°/(2*6*n), where n is an integer equal to or larger than three and the extension of the coil legs meet in the centre of the coil assembly, since this is a requirement for the coil elements to assemble into a complete three phased coil assembly.

3) Coil assembly according to claim 1, where half of the coil elements is wound counter clockwise and the other half of the coil elements are wound clockwise and that in the coil assemble the different type of coil elements are collected into groups of three, making t possible to connect the coil elements with connector wires (29) which do not cross each other.

4) Coil assembly according to claim 1, where the coil elements after assembly are inserted into a coil frame which is prefabricated with an edge for the heads of the coil elements, holes for the connector pins and on the back side slots for the connector wires arranged so that the connector wires do not cross each other.

5) Coil assembly according to claim 1, where the coil frame has holes and slots where the slots can be fitted with O-rings which will provide suitable sealing for the cooling fluid and allow cooling fluid to be in contact with both sides of the coil elements.

6) Coil assembly according to claim 1, where the holes and slots are arranged so that cooling fluid can flow from the coil assembly to coil assembly if several coil assemblies are mounted together in a multidisc machine.

7) Coil assembly according to claim 1, where Iron is placed in the gaps between the coils to increase flux density through the coil.

8) Coil assembly according to claim 1, where the wire is cut directly out of a copper plate in the shape of the coil element using techniques like wire cutting (electrical discharge machining), laser cutting, water cutting or similar.

9) Coil assembly according to claim 1 where the wire is given varying thickness around the coil in general, but especially near or in the eight slots to decrease heat generation here.

10) Coil assembly according to claim 1 where it is made space between the wires for inserting iron to increase flux density through the coil.
